(19) United States
(12) Patent Application Publication
(10) Pub. No.: US 2025/0263562 A1
(43) Pub. Date: Aug. 21, 2025

(54) COMPOSITIONS AND METHODS FOR THE REMOVAL OF PAINT FROM WATER IN AUTOMOTIVE PAINT BOOTHS

(71) Applicant: Ecolab USA Inc., St. Paul, MN (US)

(72) Inventors: Lan XIAO, Naperville, IL (US); Mingli WEI, Naperville, IL (US); Weiguo CHENG, Naperville, IL (US); Petia Todorova TONTCHEVA, Naperville, IL (US)

(73) Assignee: Ecolab USA Inc., St. Paul, MN (US)

(21) Appl. No.: 19/050,659

(22) Filed: Feb. 11, 2025

Related U.S. Application Data
(60) Provisional application No. 63/554,568, filed on Feb. 16, 2024.

(51) Int. Cl. C09D 7/00

(52) U.S. Cl. CPC C09D 7/71

(57) ABSTRACT

The present disclosure provides methods, compositions, additives, compounds, polymers, inorganic salts, and colloidal particles for detackifying paint. The methods may be carried out in any industrial paint system, such as in a paint spray booth. The compositions, additives, compounds, polymers, inorganic salts, and colloidal particles may be added to a location in the industrial paint system, such as a storage tank, reaction vessel, or aqueous medium, such as a recirculating washwater.

### TECHNICAL FIELD

The present application relates to a paint detackifier composition and, more particularly, to a paint detackifier composition for treatment of recirculating water in a paint spray booth.

### BACKGROUND

The spray painting of automobile bodies, engines and a variety of industrial and consumer articles is carried out in specialized paint spray booths. These booths provide a controlled work area for the painting operations that enhances worker safety and minimizes the amount of contaminants that adversely impact a finished paint job. The booths typically have a work area, which is where the actual painting is carried out. In spray painting, the paints are atomized to form particles via tools, such as air spray guns and electrostatic rotary-bell spray guns. Oversprayed paint mists contain highly-pelletized solvents and solid particles, such as aromatic hydrocarbon, alcohol, ketone and resin.

Paint spray booths also typically include a backsection/underbooth area, where paint overspray is removed from the air. In some systems, this is accomplished by pulling the paint-laden air through a series of disposable filters. More commonly, a moving stream of air generated by booth exhaust fans pulls the paint overspray through a curtain or spray of recirculating water effectively scrubbing the paint particles from the air into a water or aqueous phase for recovery or processing. The water and scrubbed paint particles are carried to a sump basin where the paint particles are separated from the water so that the water can be recycled and the waste paint solids can be disposed.

Paint is a highly adhesive film-forming material. It typically adheres to any exposed surface, including the interior of the spray booth, where it can build up and eventually reduce air and water flow, block drains, damage pumps and plug screens. This reduces booth efficiency and significantly increases operating costs. For this reason, chemical “detackifiers” are usually added to the recirculating water. These detackifiers improve the scrubbing efficiency of the booth, prevent the paint from adhering to booth surfaces, and aid in the collection and removal of paint solids from the recirculating water stream.

Conventionally, solvent-based or solvent-borne paints were most commonly employed in spray booths. More recently, increased environmental awareness has resulted in regulations limiting the amount of volatile organic compounds (VOCs) that can be released. This has resulted in an increased use of waterborne paints and reformulation of existing solvent-based paints to reduce VOCs. These materials, while not as tacky as solvent-based materials, are much more difficult to separate from water. Also, due to their surfactant load, they are much more prone to generating significant amounts of foam and thus may require different treatments than their solvent-based analogs. Consequently, a need has developed for detackifiers that cannot only reduce the stickiness of traditional paints but also deal with the need to control foam and improve collection of newer, reformulated water-based and hazardous air pollutant (HAP) compatible solvent-based paints.

### BRIEF SUMMARY

The present application provides paint detackifier compositions and methods of detackifying paint.

In some embodiments, the application provides a method of detackifying paint comprising adding a polymer to an aqueous medium of an industrial paint system; adding an aluminum salt and/or ferric salt to the aqueous medium; forming a colloidal particle in the aqueous medium, the colloidal particle comprising the polymer embedded within a colloidal aluminum hydroxide complex and/or a colloidal ferric hydroxide complex; adding paint to the aqueous medium; and detackifying the paint.

The present disclosure also provides an aqueous medium of an industrial paint system comprising a water source, paint, and from about 0.01 ppm to about 10,000 ppm by weight of a colloidal particle, the colloidal particle comprising a polymer embedded within a colloidal aluminum hydroxide complex and/or a colloidal ferric hydroxide complex.

The present disclosure also provides a method of detackifying paint comprising adding a composition to an aqueous medium of an industrial paint system to form a treated aqueous medium, wherein the composition comprises a colloidal particle, the colloidal particle comprising a polymer embedded within a colloidal aluminum hydroxide complex and/or a colloidal ferric hydroxide complex; adding paint to the treated aqueous medium; and detackifying the paint.

Finally, the present disclosure provides a composition comprising paint and a colloidal particle, the colloidal particle comprising a polymer embedded within a colloidal aluminum hydroxide complex and/or a colloidal ferric hydroxide complex.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, such as from about 4 to about 7 carbon atoms or about 4 to 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The term “aluminum salt” as used herein refers to an inorganic compound containing an aluminum ion, which includes, but is not limited to, alum, aluminum chloride, aluminum sulfate, PAC, and aluminum chlorohydrate. An aluminum salt is the compound that contributes aluminum ions in water solutions. It may include, but is not limited to, aluminum sulfate, aluminum chloride, aluminum phosphate, aluminum nitrate, and aluminum acetate.

The term “ferric salt” as used herein refers to an inorganic compound containing a ferric ion, which includes, but is not limited to, ferric chloride, ferric sulfate, polyferric sulfate, and polyferric chloride. A ferric salt is the compound that contributes ferric ions in water solutions. It may include, but is not limited to, ferric sulfate, ferric chloride, ferric phosphate, ferric nitrate, and ferric acetate.

The terms “co-feed,” “co-feeding,” “co-fed,” and the like refer to the addition of two or more components, ingredients, chemicals, and the like, to a location, such as a reaction vessel, storage container, and/or aqueous medium in an industrial paint system, separately but essentially/substantially at the same time and location. For example, two components, such as a polymer and an inorganic salt, may be fed into a location in a paint spray booth, such as to an aqueous medium (e.g., recirculating water system), through separate injection pipes. Each pipe may continuously or intermittently inject chemical at the same time to a single location in the spray booth or to two or more locations in the spray booth that are in close proximity to each other (e.g., within about 1 to about 12 inches, such as from about 1 to about 10 inches, from about 1 to about 8 inches, or from about 1 to about 6 inches).

The term “degree of crosslinking” refers to how many connection bonds, on average, connect one polymer chain to another polymer chain. For example, a polymer sample with an average chain length of 1000 monomer units, wherein 10 monomer units are connected to another chain has a degree of crosslinking of 1%.

The term “average particle size” refers to the average size of particles determined by a dynamic light scattering particle size analyzer when particles are less than 10 microns and by a laser diffraction size analyzer when the particle size is between 1 and 1,000 microns. The particle of the present disclosure has an average particle size of from about 0.01 to about 1,000 microns.

In accordance with the present disclosure, “detackify” means to reduce the adhesion and/or persistence of a composition of matter (typically paint) within a vessel or apparatus, such as, but not limited to, a paint gun or sprayer, a paint booth, an industrial paint system, and/or an aqueous medium in the industrial paint system, such as a recirculating washwater in a paint spray booth. This can also include the removal of a dispersion of paint, such as a water-based paint, from within a carrier medium, such as water.

The term “paint” as used herein is a generic term for liquids comprised of resin, pigment, dispersing medium, and other functional additives, which are used to paint/adhere to the surface of an object to form a solid film having protection, decoration, or other special properties. The paints may be divided into water-based paints and solvent-based paints depending on the dispersing medium used. Water-based paints refer to the paints dispersed in water as a dispersing medium. Solvent-based paints refer to the paints dispersed in organic solvents, such as aromatic hydrocarbons, as a dispersing medium.

The compositions, compounds, particles, etc., and the methods disclosed herein can be used to detackify paint, such as paint located in industrial paint systems and/or any component thereof. The term “industrial paint system,” is intended to include any portion, component, or equipment associated with an industrial paint system, such as a recirculating washwater system, a wastewater processing system, a paint spray booth, a storage container, a reaction vessel, and/or an aqueous medium associated with one or more of the foregoing, for example.

The compositions added to the industrial paint systems, which may be aqueous compositions, may include a colloidal particle, which may be interchangeably referred to as a “particle” throughout the present disclosure. The particle comprises a polymer embedded within a colloidal aluminum hydroxide complex and/or a colloidal ferric hydroxide complex.

However, in certain embodiments, the compositions added to the industrial paint system do not include a colloidal particle. Instead, a composition added to the industrial paint system may comprise, consist of, or consist essentially of a polymer and an inorganic salt. Also, a first composition comprising, consisting of, or consisting essentially of a polymer may be added to the industrial paint system and a second composition comprising, consisting of, or consisting essentially of an inorganic salt may be added to the industrial paint system. The first composition may be added before, after, and/or with (such as co-feeding) the second composition. In such embodiments, the colloidal particle may be formed in, for example, an aqueous medium of the industrial paint system.

In some embodiments, the particle of the present disclosure is formed by mixing a trivalent ion, such as an aluminum salt and/or a ferric salt, with a polymer and optionally adjusting the pH of the mixture, such as raising the pH to about 6, about 7, about 8, about 9, about 10, or about 11, for example. The polymer of the present disclosure is chemically and/or physically entangled and/or embedded in the colloidal aluminum hydroxide and/or colloidal ferric hydroxide complex. The polymer may include one or more anionic monomers, one or more cationic monomers, one or more non-ionic monomers, one or more zwitterionic monomers, or any combination of these monomers.

In some embodiments, the polymer has a net negative charge and in other embodiments, the polymer has a net positive charge or a neutral charge. For example, the polymer may be an amphoteric polymer with a net cationic charge. The polymer may also comprise, consist of, or consist essentially of a cationic monomer and a non-ionic monomer and exclude an anionic monomer and/or a zwitterionic monomer. In certain embodiments, the polymer is water-soluble. In some embodiments, the polymer comprises a carboxylic acid group.

For example, the polymer may comprise from about 0.1 mol % to about 50 mol % of the carboxylic acid, such as about 1 mol % to about 40 mol %, about 1 mol % to about 30 mol %, about 1 mol % to about 20 mol %, about 1 mol % to about 10 mol %, about 10 mol % to about 50 mol %, about 20 mol % to about 50 mol %, about 30 mol % to about 50 mol % or about 40 mol % to about 50 mol %.

In some embodiments, the polymer comprises from about 1 mol % to about 8 mol %, from about 1 mol % to about 7 mol %, from about 1 mol % to about 6 mol %, from about 1 mol % to about 5 mol %, from about 1 mol % to about 4 mol %, from about 1 mol % to about 3 mol %, or from about 1 mol % to about 2 mol % of the carboxylic acid, such as about 1 mol %, about 2 mol %, about 3 mol %, about 4 mol %, about 5 mol %, about 6 mol %, about 7 mol %, or about 8 mol % of the carboxylic acid.

Illustrative, non-limiting examples of non-ionic monomers that may be included in the polymer may be selected from acrylamide, methacrylamide, N,N-dimethylacrylamide, N,N-diethylacrylamide, N-isopropylacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-tert-butylacrylamide, N-methylolacrylamide, diallylamine, allylamine, and the like.

Illustrative, non-limiting examples of anionic monomers include acrylic acid, and its salts, including, but not limited to sodium acrylate, and ammonium acrylate, methacrylic acid, and its salts, including, but not limited to sodium methacrylate, and ammonium methacrylate, AMPS, the sodium salt of AMPS, sodium vinyl sulfonate, styrene sulfonate, maleic acid, and its salts, including, but not limited to the sodium salt, and ammonium salt, sulfonate itaconate, sulfopropyl acrylate or methacrylate or other water-soluble forms of these or other polymerizable carboxylic or sulphonic acids, sulfomethylated acrylamide, allyl sulfonate, sodium vinyl sulfonate, itaconic acid, acrylamidomethylbutanoic acid, fumaric acid, vinylphosphonic acid, vinylsulfonic acid, allylphosphonic acid, sulfomethylated acrylamide, phosphonomethylated acrylamide, and the like.

Illustrative, non-limiting examples of cationic monomers include dialkylaminoalkyl acrylates and methacrylates and their quaternary or acid salts, including, but not limited to, dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dialkylaminoalkylacrylamides or methacrylamides and their quaternary or acid salts, such as acrylamidopropyltrimethylammonium chloride, dimethylaminoethyl acrylate methyl chloride quaternary salt, dimethylaminoethyl acrylate benzyl chloride quaternary salt, dimethylaminoethyl methacrylate methyl chloride quaternary salt, dimethylaminoethyl methacrylate benzyl chloride quaternary salt, methacrylarnidopropyl trimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldiethylammonium chloride, diallyldimethylammonium chloride, and the like.

Illustrative, non-limiting examples of zwitterionic monomers include N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N, N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl) imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N, N-diallylamine ammonium betaine (MDABS), N,N-diallyl-N-methyl-N-(2-sulfoethyl) ammonium betaine, and the like.

In some embodiments, the polymer comprises a monomer selected from the group consisting of acrylamide, methacrylamide, 2-(dimethylamino)ethyl acrylate (“DMAEA”), 2-(dimethylamino)ethyl methacrylate (“DMAEM”), 3-(dimethylamino) propyl methacrylamide (“DMAPMA”), 3-(dimethylamino) propyl acrylamide (“DMAPA”), 3-methacrylamidopropyl-trimethyl-ammonium chloride (“MAPTAC”), 3-acrylamidopropyl-trimethyl-ammonium chloride (“APTAC”), N-vinyl pyrrolidone (“NVP”), diallyldimethylammonium chloride (“DADMAC”), diallylamine, 2-(acryloyloxy)-N,N,N-trimethylethanaminium chloride (“DMAEA.MCQ”), 2-(methacryloyloxy)-N, N, N-trimethylethanaminium chloride (“DMAEM.MCQ”), N,N-dimethylaminoethyl acrylate benzyl chloride (“DMAEA.BCQ”), N, N-dimethylaminoethyl methacrylate benzyl chloride (“DMAEM.BCQ”), 2-acrylamido-2-methylpropane sulfonic acid (“AMPS”), 2-acrylamido-2-methylbutane sulfonic acid (“AMBS”), acrylamide tertbutylsulfonate (“ATBS”), [2-methyl-2-[(1-oxo-2-propenyl)amino]propyl]-phosphonic acid, acrylic acid, methacrylic acid, maleic acid, itaconic acid, a salt of any of the foregoing monomer units, and any combination thereof.

In some embodiments, the polymer comprises a glyoxalated polyacrylamide (GPAM), a polyvinylamine (PVAM), a polyethylenimine (PEI), a polyamidoamine epichlorohydrin (PAE), or any combination thereof.

In particular embodiments, a polymer of the present disclosure comprises 1) acrylamide, 2) one or more of DADMAC, MAPTAC, and DMAEA.MCQ, and 3) acrylic acid. In some embodiments, a polymer of the present disclosure comprises about 97 mol % to about 85 mol % acrylamide, about 2 mol % to about 10 mol % of DADMAC, MAPTAC, and/or DMAEA.MCQ, and about 1 mol % to about 5 mol % acrylic acid.

Additional examples of polymers can be found in Table 1 and Table 2.

TABLE 1

| | | MW | | |
|---|---|---|---|---|
| Sample | polymer chemistry | (SEC/MALLS) | | Comment |
| Polymer 1 | AcAm/AA/DMAEA•MCQ 48/2/50 | >1 | mil dalton | latex |
| | (mol %) | | | |
| Polymer 2 | AcAm/AA/DMAEA•MCQ 45/5/50 | >1 | mil dalton | latex |
| | (mol %) | | | |
| Polymer 3 | DADMAC/AA 90/10 | 500-1000 | kd | solution |
| | (mol %) | | | polymer |
| Polymer 4 | DADMAC/AA 95/5 | 500-1000 | kd | solution |
| | (mol %) | | | polymer |
| Polymer 5 | AcAm/AA/DMAEA•MCQ | 300-500 | kd | solution |
| | 40/30/30 (mol %) | | | polymer |
| Polymer 6 | AcAm/AA 95/5 mol % | 100 | kd | solution |
| | | | | polymer |
| Polymer 7 | AcAm/AA 99/1 mol % | 100 | kd | solution |
| | | | | polymer |
| Polymer 8 | AcAm/DMAEA•MCQ 90/10 | 480 | kd | solution |
| | (mol %) | | | polymer |
| Polymer 9 | AcAm/DMAEA•MCQ 90/10 | 830 | kd | solution |
| | (mol %) | | | polymer |
| Polymer 10 | AcAm/DMAEA•MCQ/AA/DAAM | 500 | kd | solution |
| | 85.5/8/4/2.5 (mol %) | | | polymer |
| Polymer 11 | AcAm/DMAEA•MCQ/AA/DAAM | 920 | kd | solution |
| | 85.5/8/4/2.5 (mol %) | | | polymer |
| Polymer 12 | AcAm/DMAEA•MCQ/AA/DAAM | 1300 | kd | solution |
| | 80.5/8/4/7.5 (mol %) | | | polymer |
| Polymer 13 | AcAm/DMAEA•MCQ/AAEM | 550 | kd | solution |
| | 90/5/5 (mol %) | | | polymer |
| Polymer 14 | AcAm/DMAEA•MCQ/AA 88/8/4 | 510 | kd | solution |
| | (mol %) | | | polymer |
| Polymer 15 | AcAm/APTAC 90/10 (mol %) | 490 | kd | solution |
| | | | | polymer |
| Polymer 16 | AcAm/DMAEA•MCQ/AA = 90/8/2 | 540 | kd | solution |
| | (mole %) | | | polymer |
| Polymer 17 | AcAm/DMAEA•MCQ/ATBS = | 510 | kd | solution |
| | 90/8/2 (mole %) | | | polymer |
| Polymer 18 | AcAm/AA = 96/4 (mol) | 530 | kd | solution |
| | | | | polymer |
| Polymer 19 | AcAm/DMAEA•MCQ/AA 88/8/4 | 210 | kd | solution |
| | (mol %) | | | polymer |
| Polymer 20 | AcAm/DMAEA•MCQ/AA 88/8/4 | 240 | kd | MBA |
| | (mol %) | | | crosslinked |
| Polymer 21 | AcAm/DMAEA•MCQ/AA 88/8/4 | 310 | kd | MBA |
| | (mol %) | | | crosslinked |
| Polymer 22 | AcAm/DMAEA•MCQ/AA 86/8/6 | 470 | kd | solution |
| | (mol %) | | | polymer |
| Polymer 23 | AcAm/DMAEA•MCQ/AA 84/8/8 | 500 | kd | solution |
| | (mol %) | | | polymer |
| Polymer 24 | AcAm/DMAEA•MCQ/AA 92/4/4 | 520 | kd | solution |
| | (mol %) | | | polymer |
| Polymer 25 | AcAm/DMAEA•MCQ/AA 88/8/4 | 860 | kd | solution |
| | (mol %) | | | polymer |
| Polymer 26 | AcAm/DMAEA•MCQ/ATBS | 540 | kd | solution |
| | 88/8/4 (mol %) | | | polymer |
| Polymer 27 | AcAm/DMAEA•MCQ/AA 88/8/4 | 530 | kd | MBA |
| | (mol %) | | | crosslinked |
| Polymer 28 | AcAm/DMAEA•MCQ/AA 88/8/4 | 760 | kd | MBA |
| | (mol %) | | | crosslinked |
| Polymer 29 | AcAm/DMAEA•MCQ/AA 86/8/6 | 200 | kd | solution |
| | (mol %) | | | polymer |
| Polymer 30 | AcAm/DMAEA•MCQ/AA 84/8/8 | 210 | kd | solution |
| | (mol %) | | | polymer |
| Polymer 31 | AcAm/ATBS = 88.3/11.7 | 720 | kd | solution |
| | (mol %) | | | polymer |
| Polymer 32 | AcAm/DMAEA•MCQ/AA 90/4/6 | 260 | kd | solution |
| | (mol %) | | | polymer |
| Polymer 33 | AcAm/DMAEA•MCQ/AA 91/8/1 | 590 | kd | solution |
| | (mol %) | | | polymer |
| Polymer 34 | AcAm/DMAEA•MCQ/MAA = | ~1,000 | kd | dry powder |
| | 90/9.8/0.2 (mole %) | | | |
| Polymer 35 | AcAm/DMAEA•MCQ/AA 88/8/4 | ~1,000 | kd | dry powder |
| | (mol %) | | | |
| Polymer 36 | AcAm/DMAEA•MCQ/AA 83/15/2 | ~1,000 | kd | dry powder |
| | (mol %) | | | |
| Polymer 37 | AcAm/DMAEA•MCQ/MAA = | ~500 | kd | dry powder |
| | 90/9.5/0.5(mole %) | | | |
| Polymer 38 | AcAm/DMAEA•MCQ/MAA = | ~2,000 | kd | dry powder |
| | 90/9.9/0.1 (mole %) | | | |
| Polymer 39 | AcAm/MAA = 100 (mole %) | ~1,000 | kd | dry powder |
| Polymer 40 | homopolyacrylamide | 570 | kd | solution |
| | | | | polymer |
| Polymer 41 | AcAm/DMAEA•MCQ/AA 88/8/4 | 1500 | kd | solution |
| | (mol %) | | | polymer |
| Polymer 42 | AcAm/DMAEA/AA 88/8/4 | 530 | kd | Solution |
| | (mol %) | | | polymer |

In Table 1, DAAM refers to diacetone acrylamide, AAEM refers to acetoacetoxyethyl methacrylate, and MAA refers to methacrylic acid.

TABLE 2

| | | | | | charge | | |
|---|---|---|---|---|---|---|---|
| | | | | Monomers (rest | ratio | | |
| Polymer | Active | BV | | is acrylamide) | (mol) | MW | |
| 44 | 15% | 1360 | cps | DMAEA•MCQ:AA | 8/2 | 210 | kd |
| 45 | 15% | 1460 | cps | DMAEA•MCQ:AA | 8/4 | 210 | kd |
| 46 | 20% | 400 | cps | DADMAC:AA | 90/10 | 340 | kd |
| 47 | 20% | 1020 | cps | DMAEA:AA | 40/5 | 190 | kd |
| 48 | 20% | 1470 | cps | DMAEA•MCQ:AA | 4/2 | 120 | kd |
| 49 | 20% | 1900 | cps | DMAEA•MCQ:AA | 8/4 | 130 | kd |
| 50 | 20% | 1050 | cps | DMAEA•MCQ:AA | 4/2 | 97 | kd |
| 51 | 20% | 1120 | cps | DMAEA:AA | 4/2 | 96 | kd |
| 52 | 20% | 2200 | cps | DMAEA•MCQ:AA | 4/1 | 130 | kd |
| 53 | 20% | 3850 | cps | DMAEA•MCQ:AA | 2/1 | 140 | kd |
| 54 | 30% | 2560 | cps | DMAEA•BCQ:AA | 4/1 | 62.7 | kd |
| 55 | 30% | 950 | cps | DMAEA•BCQ:AA | 4/1, | 87.6 | kd |
| | | | | | xlinked | | |
| 56 | 30% | 5500 | cps | DADMAC:AA | 5/1 | 78.8 | kd |
| 57 | 30% | 680 | cps | DMAEA•MCQ:AA | 4/3 | 36.8 | kd |
| 58 | 30% | 4480 | cps | DMAEA:AA | 4/2 | 120 | kd |
| 59 | 30% | 1040 | cps | DMAEA•MCQ:AA | 4/1 | 40 | kd |
| 60 | 30% | 1780 | cps | DMAEA:AA | 4/1 | 45 | kd |
| 61 | 25% | 1600 | cps | DMAEA•MCQ:AA | 4/1 | 73 | kd |
| 62 | 25% | 860 | cps | DADMAC:AA | 4/1 | 56 | kd |
| 63 | 25% | 1230 | cps | MAPTAC:AA | 4/1 | 64 | kd |

In Table 2, “BV” refers to Brookfield viscosity. The BV or Brookfield viscosity is measured using a Brookfield viscometer. A typical measurement procedure includes selecting the appropriate spindle based on the expected viscosity range; attaching the spindle to the viscometer; placing the center of the spindle in the polymer solution so that the fluid level is at the immersion groove on the spindle shaft; starting the viscometer and allowing it to reach a stable rotational speed and viscosity; and recording the viscosity reading once the measurement stabilizes.

Specific examples of viscosities are provided in Table 2 but the polymers of the present disclosure may have other viscosities as well. For instance, a polymer of the present disclosure may have a viscosity ranging from about 100 cps to about 10,000 cps, such as from about 100 cps to about 8,000 cps, about 100 cps to about 6,000 cps, about 100 cps to about 4,000 cps, about 100 cps to about 3,000 cps, about 100 cps to about 2,000 cps, about 100 cps to about 1,000 cps, about 300 cps to about 1,000 cps, about 300 cps to about 2,000 cps, about 300 cps to about 3,000 cps, about 300 cps to about 4,000 cps, about 500 cps to about 3,000 cps, or about 1,000 cps to about 3,000 cps.

The mole percentage of each monomer in the polymer is not particularly limited. In some embodiments, the polymer comprises from about 1 mol % to about 99 mol % of the cationic monomer. For example, the polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a cationic monomer.

In some embodiments, the polymer comprises from about 0 mol % to about 99 mol % of the anionic monomer. For example, the polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of an anionic monomer.

In some embodiments, the polymer comprises from about 1 mol % to about 99 mol % of a non-ionic monomer. For example, the polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a non-ionic monomer.

In some embodiments, the polymer comprises from about 0 mol % to about 99 mol % of a zwitterionic monomer. For example, the polymer may comprise from about 1 mol % to about 90 mol %, from about 1 mol % to about 80 mol %, from about 1 mol % to about 70 mol %, from about 1 mol % to about 60 mol %, from about 1 mol % to about 50 mol %, from about 1 mol % to about 40 mol %, from about 1 mol % to about 30 mol %, from about 1 mol % to about 20 mol %, from about 1 mol % to about 10 mol %, from about 10 mol % to about 99 mol %, from about 20 mol % to about 99 mol %, from about 30 mol % to about 99 mol %, from about 40 mol % to about 99 mol %, from about 50 mol % to about 99 mol %, from about 60 mol % to about 99 mol %, from about 70 mol % to about 99 mol %, from about 80 mol % to about 99 mol %, or from about 90 mol % to about 99 mol % of a zwitterionic monomer.

In certain embodiments, the polymer disclosed herein comprises from about 2 mol % to about 10 mol % of the cationic monomer, about 1 mol % to about 5 mol % of the anionic monomer, and the balance being a non-ionic monomer. For example, the polymer may comprise from about 4 mol % to about 10 mol % of the cationic monomer, such as about 5 mol %, 6 mol %, about 7 mol %, about 8 mol %, or about 9 mol % of the cationic monomer, and about 1 mol %, about 2 mol %, about 3 mol %, about 4 mol %, or about 5 mol % of the anionic monomer.

The polymer may have any ratio of cationic monomer to anionic monomer, such as a ratio of about 2:1, about 3:1, about 4:1, about 5:1, about 6:1, about 7:1, about 8:1, about 9:1, or about 10 or more: 1.

In some embodiments, the polymer is not a disaccharide or a polysaccharide. In certain embodiments, the polymer excludes monosaccharide monomers. In certain embodiments, the composition or particle disclosed herein excludes a polysaccharide, such as an anionic polysaccharide. In some embodiments, the polymer excludes a hydroxamic acid group, an isocyanate group, N-bromoamine and/or N-chloroamine. In certain embodiments, the polymer comprises unmodified/unreacted amide and/or amine side chains. In some embodiments, if the polymer comprises amide and/or amine side chains, less than 10% of those side chains, such as less than 9%, 8%, 7%, 6%, 5%, 4%, 3%, 2%, 1% or 0%, are modified/reacted with other functional groups before the polymer is embedded within a colloidal aluminum hydroxide complex and/or a colloidal ferric hydroxide complex.

In some embodiments, a polymer of the present disclosure is a water-soluble amphoteric polymer (optionally with a net cationic charge) containing a carboxylic acid group. In certain embodiments, a polymer of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The weight average molecular weight of the polymer is not particularly limited. In some embodiments, the polymer has a molecular weight ranging from about 10,000 Da to about 10,000,000 Da. For example, the polymer may have a molecular weight ranging from about 10,000 Da to about 5,000,000 Da, from about 10,000 Da to about 3,000,000 Da, from about 10,000 Da to about 1,000,000 Da, from about 10,000 Da to about 750,000 Da, from about 10,000 Da to about 500,000 Da, from about 10,000 Da to about 250,000 Da, from about 10,000 Da to about 100,000 Da, from about 10,000 Da to about 50,000 Da, from about 100,000 Da to about 10,000,000 Da, from about 500,000 Da to about 10,000,000 Da, from about 750,000 Da to about 10,000,000 Da, from about 1,000,000 Da to about 10,000,000 Da, from about 3,000,000 Da to about 10,000,000 Da, from about 5,000,000 Da to about 10,000,000 Da or from about 8,000,000 Da to about 10,000,000 Da.

As additional examples, the weight average molecular weight of the polymer may be from about 200,000 Da to about 1,000,000 Da, such as from about 200,000 Da to about 800,000 Da, from about 200,000 Da to about 600,000 Da, or from about 300,000 to about 500,000 Da.

In some embodiments, the polymer of the present disclosure comprises a Huggins constant of about 0.0 to about 1.0. For example, the Huggins constant of a polymer disclosed herein may be from about 0.1 to about 0.9, about 0.1 to about 0.8, about 0.1 to about 0.7, about 0.1 to about 0.6, about 0.1 to about 0.5, about 0.1 to about 0.4, about 0.1 to about 0.3, about 0.1 to about 0.2, about 0.2 to about 0.8, about 0.2 to about 0.7, or about 0.2 to about 0.6.

The Huggins Equation is an empirical equation used to relate the reduced viscosity of a dilute polymer solution to the concentration of the polymer in solution. The Huggins equation states:

$$\frac{{η}_{s}}{c} = [ η ] + {{k}_{H} [ η ]}^{2} c$$

where ns is the specific viscosity of a solution at a given concentration of a polymer in solution, [η] is the intrinsic viscosity of the solution, K_{H} is the Huggins coefficient, and c is the concentration of the polymer in solution.

The Huggins equation is a useful tool because it can be used to determine the intrinsic viscosity [η] or IV, from experimental data by plotting ηₛ/c versus the concentration of the solution, c.

The Huggins constant may be calculated as follows:

$$Huggins constant = \frac{slope of ( R S V ∼ c )}{I {V}^{2}}$$

where “RSV” stands for reduced specific viscosity and “IV” stands for intrinsic viscosity. The RSV is measured at a given polymer concentration and temperature and calculated as follows:

$$R S V = \frac{[ ( \frac{η}{{η}_{0}} ) - 1 ]}{c}$$

wherein η=viscosity of polymer solution; η₀=viscosity of solvent at the same temperature; and c=concentration of polymer in solution. The units of concentration “c” are (grams/100 ml or g/deciliter). Therefore, the units of RSV are dL/g. In accordance with the present disclosure, for measuring RSV, the solvent used is 1.0 molar sodium nitrate solution. The polymer concentration is typically about 0.1 to about 1.0 g/dL. The RSV is measured at about 30° C. The viscosities η and η₀ are measured using a Cannon Ubbelohde semimicro dilution viscometer, size 75.

In the SEC/MALLS analysis of the present disclosure, the polymer solution was diluted with an aqueous mobile phase (0.3M NaCl, 0.1M NaH₂PO₄, 25 ppm NaN₃) to about 0.05%. About 200 μL of the solution was injected into a set of TSKgel PW columns (TSKgel GMPW+GMPW+G1000 PW), and the mobile phase had a flow rate of about 1.0 mL/min. Bovine serum albumin (BSA) was used as standard for multiangle light scattering detector normalization. The calibration constant of the RI detector was verified with sodium chloride (NaCl).

Linearity of the polymer can be defined using Huggins constant, with a lower Huggins constant indicating a more linear polymer.

Certain polymers disclosed herein may have a conformation plot slope of about 0.05 to about 1.0. For example, the polymers may have a conformation plot slope of about 0.1 to about 1.0, about 0.2 to about 1.0, about 0.3 to about 1.0, about 0.4 to about 1.0, about 0.5 to about 1.0, about 0.05 to about 0.5, about 0.05 to about 0.3, or about 0.05 to about 0.1.

SEC/MALLS characterizes LCB (long chain branching) in macromolecules through conformation plots. A conformation plot is a log-log plot of the rms radius (radius of gyration, Rg) versus molar mass (M). Light scattering implemented as SEC/MALLS can effectively and rapidly characterize branching in polymers. Polymers with LCB exhibit lower slopes than the corresponding linear polymer, which differ depending on the extent of LCB. A conformation plot can be constructed by SEC/MALLS analysis (see AN1005: Identifying short-chain branched polymers with conformational analysis, Wyatt Technology, Chris Deng, Ph.D., the disclosure of which is incorporated into the present application in its entirety).

The conformation plot is acquired by taking the mean radius of gyration calculated based on the molecular weight at each point and the corresponding molecular weight on the chromatogram, and a corresponding slope is calculated from the conformation plot.

A linear polymer should have higher conformation slope, such as from about 0.5 to 1, about 0.6 to 1, about 0.7 to 1, or about 0.8 to 1. A crosslinked polymer should have a lower conformation slope, typically below about 0.5, such as from about 0 to about 0.4, about 0 to about 0.3, about 0 to about 0.2, or about 0 to about 0.1.

Illustrative, non-limiting examples of polymers of the present disclosure along with their corresponding Huggins constant and conformation plot slope are listed in Table 3.

TABLE 3

| | | | | Conformation | Huggins | |
|---|---|---|---|---|---|---|
| Sample | polymer composition | MW | | Plot Slope | Constant | Comment |
| A | AcAm/DMAEA•MCQ/AA | 510 | kd | 0.92 | 0.37 | linear |
| | 88/8/4 (mol %) | | | | | |
| B | AcAm/DMAEA•MCQ/AA | 480 | kd | 0.82 | 0.33 | linear |
| | 88/8/4 (mol %) | | | | | |
| C | AcAm/DMAEA•MCQ/AA | 420 | kd | 0.92 | 0.31 | linear |
| | 88/8/4 (mol %) | | | | | |
| D | AcAm/DMAEA•MCQ/AA | 370 | kd | 0.52 | 0.39 | linear |
| | 88/8/4 (mol %) | | | | | |
| E | AcAm/DMAEA•MCQ/AA | 290 | kd | 0.56 | 0.32 | linear |
| | 88/8/4 (mol %) | | | | | |
| F | AcAm/DMAEA•MCQ/AA | 350 | kd | 0.55 | 0.42 | linear |
| | 88/8/4 (mol %) | | | | | |
| G | AcAm/DMAEA•MCQ/AA | 730 | kd | 0.4 | 0.28 | MBA |
| | 88/8/4 (mol %) | | | | | crosslinked |
| H | AcAm/DMAEA•MCQ/AA | 460 | kd | 0.53 | 0.3 | MBA |
| | 88/8/4 (mol %) | | | | | crosslinked |
| I | AcAm/DMAEA•MCQ/AA | 760 | kd | 0.43 | 0.39 | MBA |
| | 88/8/4 (mol %) | | | | | crosslinked |
| J | AcAm/DMAEA•MCQ/AA | 500 | kd | 0.79 | 0.36 | linear |
| | 90/8/2 (mol %) | | | | | |
| K | AcAm/DMAEA•MCQ/AA | 490 | kd | 0.85 | 0.44 | linear |
| | 90/8/2 (mol %) | | | | | |
| L | AcAm/DMAEA•MCQ/AA | 540 | kd | 0.8 | 0.3 | linear |
| | 90/8/2 (mol %) | | | | | |
| M | AcAm/DMAEA•MCQ/AA | 730 | kd | 0.31 | 0.11 | MBA |
| | 90/8/2 (mol %) | | | | | crosslinked |
| N | AcAm/DMAEA•MCQ/AA | 480 | kd | 0.4 | 0.11 | MBA |
| | 90/8/2 (mol %) | | | | | crosslinked |
| O | AcAm/DMAEA•MCQ/AA | 940 | kd | 0.33 | 0.18 | MBA |
| | 90/8/2 (mol %) | | | | | crosslinked |
| P | AcAm/DMAEA•MCQ/AA | 1100 | kd | 0.3 | 0.35 | MBA |
| | 90/8/2 (mol %) | | | | | crosslinked |
| Q | AcAm/DMAEA•MCQ/AA | 940 | kd | 0.37 | 0.4 | MBA |
| | 90/8/2 (mol %) | | | | | crosslinked |
| R | AcAm/DMAEA•MCQ/AA | 820 | kd | 0.39 | 0.3 | MBA |
| | 90/8/2 (mol %) | | | | | crosslinked |
| S | AcAm/DMAEA•MCQ/AA | 570 | kd | 0.54 | 0.4 | MBA |
| | 90/8/2 (mol %) | | | | | crosslinked |
| T | AcAm/DMAEA•MCQ/AA | 950 | kd | 0.36 | 0.33 | MBA |
| | 90/8/2 (mol %) | | | | | crosslinked |
| U | AcAm/AA/DMAEA/AA | 530 | kd | 0.87 | 0.25 | linear |
| | 88/8/4 (mol %) | | | | | |

In some embodiments, the polymer may be crosslinked with the aluminum or iron of the aluminum hydroxide complex or the ferric hydroxide complex. In some embodiments, the polymer has a degree of crosslinking greater than 1%, greater than 2%, greater than 3%, greater than 4%, greater than 5%, greater than 6%, greater than 7%, greater than 8%, greater than 9% or greater than 10%. In certain embodiments, the polymer has a degree of crosslinking less than about 50%, less than about 40%, less than about 30% or less than about 20%. For example, the polymer may have a degree of crosslinking from about 1% to about 50%, from about 5% to about 50%, from about 10% to about 50%, from about 15% to about 50%, from about 20% to about 50%, from about 30% to about 50%, from about 2% to about 25%, from about 2% to about 20%, from about 2% to about 15%, from about 2% to about 10%, from about 3% to about 25%, from about 3% to about 20%, from about 3% to about 15%, from about 3% to about 10%, from about 4% to about 25%, from about 4% to about 20%, from about 4% to about 15% or from about 4% to about 10%.

In some embodiments, the crosslink is formed from an interaction/reaction of an anionic monomer and the iron and/or aluminum. For example, the polymer may comprise a carboxylic acid group and a crosslink may be formed from a reaction/interaction between the carboxylic acid group and the iron and/or aluminum.

The polymer of the present disclosure may have, in some embodiments, a cationic charge density of greater than about 0.1 meq/g, greater than about 0.5 meq/g, greater than about 1 meq/g, or greater than about 1.5 meq/g at neutral pH. For example, the polymer may have a cationic charge density of about 0.5 to about 8.5, such as about 0.5 to about 8, about 0.5 to about 7.5, about 0.5 to about 7, about 0.5 to about 6.5, about 0.5 to about 6, about 0.5 to about 5.5, about 0.5 to about 5, about 0.5 to about 4.5, about 0.5 to about 4, about 0.5 to about 3.5, about 0.5 to about 3, about 0.5 to about 2.5, about 0.5 to about 2, about 0.5 to about 1.5, about 0.5 to about 1, about 1 to about 8.5, about 1.5 to about 8.5, about 2 to about 8.5, about 2.5 to about 8.5, about 3 to about 8.5, about 3.5 to about 8.5, about 4 to about 8.5, about 4.5 to about 8.5, about 5 to about 8.5, about 5.5 to about 8.5, about 6 to about 8.5, about 6.5 to about 8.5, about 7 to about 8.5, about 7.5 to about 8.5, or about 8 to about 8.5 meq/g at neutral pH (about 7).

An aqueous medium may comprise the colloidal particle (thereby forming an aqueous colloidal composition) and the aqueous medium may have a pH, for example, from about 2 to about 10, from about 4.5 to about 9, from about 5.5 to about 8.5, from about 5.5 to about 8, from about 6 to about 9, from about 6.5 to about 8.5, or from about 7 to about 8. In some embodiments, the aqueous medium comprises a pH from about 6 to about 9.

In some embodiments, the colloidal particle is water-insoluble.

In certain embodiments, the colloidal particle is prepared by adding a polymer disclosed herein to an aqueous medium, such as water, and then adding an aluminum salt and/or ferric salt to the medium. The polymer and metal/inorganic salt can be added continuously, intermittently, and in any order to the medium. In some embodiments, the polymer and metal salt are co-fed into the medium.

In some embodiments, the medium comprises about 0.01 wt. % to about 10 wt. % of the polymer, such as from about 0.01 wt. % to about 9 wt. %, about 0.01 wt. % to about 8 wt. %, about 0.01 wt. % to about 7 wt. %, about 0.01 wt. % to about 6 wt. %, about 0.01 wt. % to about 5 wt. %, about 0.01 wt. % to about 4 wt. %, about 0.01 wt. % to about 3 wt. %, about 0.01 wt. % to about 2 wt. %, or about 0.01 wt. % to about 1 wt. % of the polymer before particle formation.

In some embodiments, the medium comprises a weight ratio of the aluminum salt and/or the ferric salt to the polymer from about 1:1 to 100:1. For example, the medium may comprise a weight ratio of the aluminum salt and/or the ferric salt to the polymer from about 2:1, about 3:1, about 4:1, about 5:1, about 10:1, about 20:1, about 30:1, about 40:1, about 50:1, about 60:1, about 70:1, about 80:1, or about 90:1 before particle formation. In some embodiments, the medium comprises more aluminum salt and/or ferric salt than polymer before particle formation.

As an illustrative example, if a weight ratio of PAC (based on Al₂O₃) to the polymer was about 1:1, the aluminum ion would be about 159 mol % of the polymer. As an additional, non-limiting example, if a weight ratio of PAC to polymer was about 0.1:1, the aluminum ion would be about 15.9 mol % of the polymer.

The aqueous medium may have a pH from, for example, about 1.0 to about 6.5 and, after at least some of the polymer and metal salt have been added, the pH may be raised to about 7.0, about 7.5, about 8.0, about 8.5, about 9, or higher. In some embodiments, the pH of the medium may be raised by adding a base, such as sodium hydroxide, diluting the composition with water, etc. In certain embodiments, the pH of the medium comprising, consisting of, or consisting essentially of the polymer and/or the inorganic salt is raised by adding it to a process water/aqueous medium of the industrial paint system, wherein a pH of the process water may be from, for example, about 6.5 to about 9.5, about 7 to about 9.5, about 7.5 to about 9.5, etc. While an amount of colloidal particle may form in a composition that comprises, consists of, or consists essentially of the polymer and the inorganic salt before the pH is raised, the substantial majority or all of the colloidal particle forms after the pH is raised, for example, to about 6.5 or more, about 7 or more, or about 7.5 or more.

The colloidal particle has a weight ratio of aluminum hydroxide and/or ferric hydroxide to the polymer from about 1:1 to about 100:1. For example, the weight ratio may be from about 2:1 to about 75:1, from about 5:1 to about 50:1, from about 7:1 to about 40:1, from about 9:1 to about 30:1 or from about 10:1 to about 25:1. In certain embodiments, a weight ratio of the aluminum hydroxide and/or ferric hydroxide to the polymer is from about 10:1 to about 20:1.

The colloidal particle comprises from about 1 wt. % to about 99 wt. % of the polymer. For example, the colloidal particle may comprise from about 1 wt. % to about 50 wt. %, from about 1 wt. % to about 25 wt. %, from about 1 wt. % to about 15 wt. %, from about 1 wt. % to about 10 wt. %, from about 1 wt. % to about 5 wt. %, from about 5 wt. % to about 20 wt. %, from about 5 wt. % to about 15 wt. %, or from about 5 wt. % to about 10 wt. % of the polymer.

The colloidal particle comprises from about 1 wt. % to about 99 wt. % of the inorganic salt, such as aluminum hydroxide and/or the ferric hydroxide. For example, the colloidal particle may comprise form about 15 wt. % to about 99 wt. %, from about 25 wt. % to about 99 wt. %, from about 50 wt. % to about 99 wt. %, from about 75 wt. % to about 99 wt. %, from about 85 wt. % to about 99 wt. %, or from about 90 wt. % to about 99 wt. % of the inorganic salt, such as aluminum hydroxide and/or the ferric hydroxide.

The colloidal particle has an average particle size ranging from about 0.01 to about 1,000 microns. For example, the average particle size may be from about 0.05 to about 100 microns, from about 0.05 to about 80 microns, from about 0.05 to about 60 microns, from about 0.05 to about 40 microns, from about 0.05 to about 20 microns, from about 0.05 to about 10 microns, from about 0.1 to about 50 microns, from about 0.1 to about 40 microns, from about 0.1 to about 30 microns, from about 0.1 to about 20 microns, or from about 0.1 to about 10 microns.

As additional examples, the average particle size may be from about 50 nm to about 500 nm, such as from about 50 nm to about 400 nm, about 50 nm to about 300 nm, about 100 nm to about 200 nm, about 100 nm to about 300 nm, or about 100 nm to about 400 nm.

In some embodiments, an aqueous medium (e.g., recirculating water)/composition may comprise at least about 0.01 wt. % of the colloidal particles, such as greater than 0.01 wt. % of the particles to about 20 wt. % of the particles, greater than about 0.02 wt. % to about 15 wt. %, greater than about 0.05 wt. % to about 10 wt. %, greater than about 1 wt. % to about 10 wt. %, greater than about 2 wt. % to about 8 wt. %, greater than about 3 wt. % to about 9 wt. %, greater than about 4 wt. % to about 10 wt. %, or greater than about 5 wt. % to about 9 wt. % of the particles. The percentages in this paragraph refer to the dosage of colloidal particles relative to paint particles in the aqueous medium.

The compositions and/or particles disclosed herein may include additional additives, such as a flocculant. A flocculant may be added to cause oversprayed paint mists in the water to rapidly flocculate and be separated from the water. A natural or synthetic polymeric flocculant may be added to the industrial paint system separately or it may be added with a composition of the present disclosure (or with any compounds disclosed herein). In some embodiments, the polymeric flocculant may comprise at least about 0.1 mol % hydroxyl functionality, such as from about 0.1 mol % to about 30 mol %, about 0.1 mol % to about 20 mol %, about 0.1 mol % to about 15 mol %, about 0.1 mol % to about 10 mol %, about 0.1 mol % to about 5 mol %, or about 0.1 mol % to about 1 mol %.

The weight average molecular weight of the polymeric flocculant may range from about 2.5×10⁵ Daltons to about 25×10⁵ Daltons, such as from about 2.5×10⁵ Daltons to about 20×10⁵ Daltons, about 2.5×10⁵ Daltons to about 15×10⁵ Daltons, about 2.5×10⁵ Daltons to about 10×10⁵ Daltons, or about 2.5×10⁵ Daltons to about 5×10⁵ Daltons.

The polymeric flocculant may be easily biodegradable and capable of reacting with a complex polymeric salt of an amphoteric metal to form a crosslinked gel at neutral or alkaline pH values. Suitable products include polymers of synthetic polymers, such as acrylamide, or natural polymers, such as chitosan or guar gum.

In some embodiments, a flocculant may comprise a water-soluble (or water-dispersible) anionic, cationic, amphoteric, or nonionic polymer having at least 3 repeat units attributable to or derived from the polymerization of one or more monomeric compounds. Non-limiting examples include, but are not limited to, polyacrylamide (homopolymer) and copolymers, terpolymers, or higher interpolymers of 1 mol % to 99 mol % acrylamide with one or more of: acrylic acid or a conjugate base thereof; 2-acrylamido-2-methyl-1-propanesulfonic acid or a conjugate base thereof; methacrylic acid or a conjugate base thereof; dimethylaminoethylacrylate quaternized with a C₁-C₆ alkyl halide such as methyl chloride, ethyl chloride, n-butyl chloride, or isohexyl chloride; or a C₁-C₆ alkyl sulfate such as methyl sulfate, ethyl sulfate, n-pentyl sulfate, or n-hexyl sulfate; dimethylaminoethylmethacrylate quaternized with a C₁-C₆ alkyl halide or a C₁-C₆ alkyl sulfate; diallyl dialkyl ammonium halides such as diallyl dimethyl ammonium chloride (DADMAC); methacryloyloxyethyl trimethylammonium methyl sulfate (METAMS), methacrylamido propyl trimethylammonium chloride (MAPTAC), acryloyloxyethyl trimethyl ammonium chloride (AETAC), methacryloyloxyethyl trimethylammonium chloride (METAC).

Additional examples include homopolymers, copolymers, or higher interpolymers of any of the foregoing monomers, such as homopolymers, copolymers, or higher interpolymers of METAMS, MAPTAC, AETAC and/or METAC.

Additional additives also include other polymeric compounds that may, for example, act as co-flocculants and facilitate rapid separation of the paint solids from the aqueous medium. For example, high molecular weight polymers of acrylamide may be added. These include copolymers containing, for example, amine and/or hydroxyl functional groups.

In some embodiments, a composition of the present disclosure comprises, consists of, or consists essentially of the colloidal particle. In some embodiments, a composition comprises, consists of, or consists essentially of the colloidal particle and an additional additive. In some embodiments, a composition comprises, consists of, or consists essentially of the colloidal particle and a coagulant. In some embodiments, a composition comprises, consists of, or consists essentially of the colloidal particle, a coagulant, and a flocculant. In some embodiments, a composition comprises, consists of, or consists essentially of the polymer and optionally a coagulant and/or flocculant. In some embodiments, a composition comprises, consists of, or consists essentially of the inorganic salt and optionally a coagulant and/or flocculant. In some embodiments, a composition comprises, consists of, or consists essentially of the polymer and the inorganic salt, and optionally a coagulant and/or flocculant. In some embodiments, a composition comprises, consists of, or consists essentially of the polymer, the inorganic salt, and the colloidal particle, and optionally a coagulant and/or flocculant.

The coagulant may comprise, for example, a polyionic compound, an inorganic salt, an organic compound, or a combination thereof. Illustrative, non-limiting examples include inorganic aluminum, magnesium, or iron salt compounds. Specific examples include aluminum sulfate, aluminum chloride, magnesium chloride, magnesium oxide, ferric chloride, ferric sulfate, polyaluminum chloride, and aluminum chloride hydroxide. Additional examples of coagulants include a polyphosphonium compound, a polysulfonium compound, or a non-polymeric polyionic compound having three or more ionic moieties bonded thereto. Illustrative examples of an organic compound include DADMAC and epichlorohydrin dimethylamine (EPI-DMA).

The amount of the optional additional additive may vary depending upon the particular circumstances. For example, the composition and/or medium may comprise from about 0.1 wt. % to about 20 wt. % of the additional additive, such as from about 0.1 wt. % to about 18 wt. %, about 0.1 wt. % to about 16 wt. %, about 0.1 wt. % to about 14 wt. %, about 0.1 wt. % to about 12 wt. %, about 0.1 wt. % to about 10 wt. %, about 0.1 wt. % to about 8 wt. %, about 0.1 wt. % to about 6 wt. %, about 0.1 wt. % to about 4 wt. %, about 0.1 wt. % to about 2 wt. %, or about 0.1 wt. % to about 1 wt. % of the additional additive.

If the compositions disclosed herein are prepared as a liquid concentrate, that concentrate may then be added to the industrial paint system (e.g., aqueous medium of a paint spray booth) for use as a primary detackifying additive and/or coagulating additive for oversprayed paint solids.

In some embodiments, the detackifying compositions of the present disclosure may be fed to an industrial paint system, such as to the recirculating washwater system of a paint spray booth. In operation, the paint overspray contacts the recirculating washwater of the booth scrubber section. When the paint overspray contacts the washwater containing the colloidal particle, the paint overspray becomes rapidly detackified and coagulated, causing it to separate from the system water as a sludge layer. Additional additives may optionally be added to help separate the coagulated paint sludge with liquid-solid separation techniques. Optional equipment may also be used, such as floatation units, centrifuges and skimmers.

As an illustrative, non-limiting example, a method of using the compositions, compounds, particles, etc., of the present disclosure may be carried out in an industrial paint system. The method may be used to treat oversprayed paint particles in a circulating washwater system. The method may be used to detackify paint from a circulating water system or any other type of aqueous paint capture system. In such methods, oversprayed paint is contacted with an aqueous medium, such as washwater. In some embodiments, the aqueous medium contains a colloidal particle of the present disclosure before the oversprayed paint is captured in the aqueous medium. For example, a particle of the present disclosure may be added to the aqueous medium and/or a particle of the present disclosure may be formed in the aqueous medium by feeding the inorganic salt, such as ferric salt and/or aluminum salt, and the polymer to the aqueous medium. The methods disclosed herein may also include a step of separating the treated oversprayed paint particles from the aqueous medium (e.g., paint system washwater).

In some embodiments, after the paint is detackified, it is passed on to a receptacle including, but not limited to, a pit where an additional flocculant, which could be anionic, may be added as the water and detackified paint return to the receptacle from the paint spray booths. The additional flocculant may be for the purpose of agglomerating the detackified paint particles and improving flotation. This may result in a sludge, which may move across the surface of the receptacle to a weir box or similar vessel where the floating material is skimmed off and transferred to a palin or sludge removal device. As the sludge enters the palin, it may be treated with another flocculant, which may be cationic, anionic, zwitterionic, amphoteric with a net negative charge, or amphoteric with a net positive charge.

In some embodiments, the polymer may be premixed with a trivalent ion, such as an aluminum salt and/or a ferric salt, in an aqueous medium to form the particle and the resulting mixture/composition may be added to the industrial paint system. The pH of the composition can optionally be adjusted as described herein. In certain embodiments, the polymer and inorganic salt, such as aluminum salt and/or ferric salt may be fed separately into the industrial paint system (e.g., into the recirculating washwater) and the colloidal particle may be formed in the industrial paint system (e.g., in the washwater). In certain embodiments, the pH of the washwater may be adjusted as described herein. The components (e.g., polymer and inorganic salt) may be fed to the medium sequentially in any order, together as a mixture, co-fed, or any combination thereof.

In some embodiments, a composition comprises the polymer and inorganic salt, such as the aluminum salt and/or the ferric salt. This composition may optionally comprise an amount of a colloidal particle as defined herein, such as from about 0 wt. % to about 20 wt. %, about 0 wt. % to about 15 wt. %, about 0 wt. % to about 10 wt. %, about 0 wt. % to about 5 wt. %, or about 0 wt. % to about 1 wt. %.

The composition may be an aqueous composition comprising a pH from about 1 to about 14, such as from about 1 to about 10, from about 1 to about 9, from about 1 to about 8.5, from about 3 to about 14, from about 3 to about 10, from about 3 to about 8.5, from about 3.5 to about 8.5, from about 5 to about 14, from about 5 to about 10 or from about 5 to about 8. In certain embodiments, the composition comprises a pH of about 1 to about 7, such as from about 3 to about 5.

In some embodiments, the composition comprises a weight ratio of the aluminum salt and/or the ferric salt to the polymer from about 0.05:1 to 100:1. For example, the composition may comprise a weight ratio of the aluminum salt and/or the ferric salt to the polymer from about 0.1:1, about 0.5:1, about 1:1, about 5:1, about 10:1, about 20:1, about 30:1, about 40:1, about 50:1, about 60:1, about 70:1, about 80:1, or about 90:1.

In some embodiments, the composition comprises more aluminum salt and/or ferric salt than polymer.

In certain embodiments, the composition comprises from about 0.01 wt. % to about 10 wt. % of the polymer. For example, the composition may comprise from about 0.01 wt. % to about 9 wt. %, from about 0.01 wt. % to about 8 wt. %, from about 0.01 wt. % to about 7 wt. %, from about 0.01 wt. % to about 6 wt. %, from about 0.01 wt. % to about 5 wt. %, from about 0.01 wt. % to about 4 wt. %, from about 0.01 wt. % to about 3 wt. %, from about 0.01 wt. % to about 2 wt. %, or from about 0.01 wt. % to about 1 wt. % of the polymer.

In some embodiments, the polymer comprises one or more anionic monomers. The pH of the aqueous composition may be adjusted such that it is greater than the lowest pKa value of a monomer of the polymer. The pKa of an anionic monomer equals the pH value while 50% anionic monomer carries an anionic charge. When the solution pH is higher than the pKa, more anionic charge sites will appear on the polymer chain that can promote its interaction with trivalent ions and their derivatives. If the aqueous composition comprising the polymer is being added to a medium separately from the inorganic salt, such as when the polymer and inorganic salt are being co-fed into a medium, the pH of the aqueous composition comprising the polymer may be adjusted.

In some embodiments, the polymer and the aluminum salt and/or ferric salt are fed or co-fed into a location, such as into a reaction vessel, a storage tank, the recirculating water of a paint spray booth, etc. Additional additives, as defined herein, may also be fed before, after, and/or with the polymer, inorganic salt, and/or particle into the location (e.g., aqueous medium, reaction vessel, storage tank, etc.). In some embodiments when the polymer and inorganic salt are co-fed or fed separately into a location, the particle is formed in the location. In some embodiments, the process water receiving the polymer, inorganic salt, and/or colloidal particle has a pH from about 5.5 to about 10, about 6 to about 10, about 6.5 to about 10, about 7 to about 10, about 7.5 to about 10, or about 8 to about 10. However, that pH may be adjusted as described herein.

For example, an injection pipe may lead to a location in the washwater and the pipe may inject polymer into the water. A pipe, such as an adjacent pipe, may be present and it may add additional chemical, such as inorganic salt. Each chemical addition may be continuous or intermittent, for example. Since the injection pipes are adjacent or substantially adjacent to one another, the chemicals are fed to substantially the same location in the process water at substantially the same time. The chemicals may interact in the water and form a colloidal particle.

Thus, in some embodiments, a colloidal particle is formed in the process water and optionally a colloidal particle is additionally or alternatively added to the process water. In some embodiments, a colloidal particle may form in a composition before the composition is added to the process water and optionally a colloidal particle may form in the process water.

Any appropriate aluminum salt may be selected and used with the presently disclosed innovation. In some embodiments, the aluminum salt is selected from the group consisting of aluminum chloride, aluminum chloride hydrate, aluminum sulfate, alum, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

Any appropriate ferric salt may be selected and used with the presently disclosed innovation. In some embodiments, the ferric salt is selected from the group consisting of ferric chloride, ferric sulfate, a polyferric salt, and any combination thereof.

The compositions, particles, polymers, and inorganic salts (e.g., aluminum salts and/or ferric salts) can be added at any location or at any time during an industrial painting operation. Two or more of the components may be added together and/or two or more components may be fed or co-fed into the location, such as the aqueous medium. For example, the compositions, particles, polymers, aluminum salts and/or ferric salts may be added together, separately, and/or co-fed to the recirculating washwater.

In some embodiments, the polymer is added to the location (e.g., aqueous medium) before, after, and/or concurrently with the aluminum and/or ferric salt. The polymer and aluminum and/or ferric salt may be added at the same location and/or at different locations in the medium.

In some embodiments, a composition comprising any one or more of aluminum salt, ferric salt, polymer, and particle is added during an industrial painting operation. In some embodiments, one or more of the aluminum salt, ferric salt, polymer, and particle may be added separately into the system, such as by co-feeding. In certain embodiments, the aluminum and/or ferric salt and the polymer are premixed prior to addition to the system.

The amount of the particle added to, or present in the system (e.g., aqueous medium), typically ranges from about 0.01 ppm to about 10,000 ppm, based on water flow and paint content, although higher or lower amounts may be used. In some embodiments, about 0.1 ppm to about 7,000 ppm, about 1 ppm to about 5,000 ppm, about 1 ppm to about 2,500 ppm, about 5 ppm to about 1,000 ppm, about 5 ppm to about 500 ppm, about 5 ppm to about 100 ppm, about 25 ppm to about 150 ppm, about 50 ppm to about 300 ppm, about 100 ppm to about 500 ppm, about 100 ppm to about 300 ppm, or about 200 ppm to about 400 ppm of the colloidal particle is added to, or is present in, the aqueous medium.

If desired, the pH of the aqueous medium may be adjusted, for example, to provide more favorable conditions for particle formation. In some embodiments, the pH of the aqueous medium (e.g., recirculating washwater system) is maintained between about 6.0 and about 11.0, such as between about 6.5 and about 10, about 7 and about 10, about 7.5 to about 9.5, about 7 to about 9, about 7.5 to about 9, or about 8 to about 9. The pH may be periodically adjusted using methods and products commonly used in the art, such adding sodium hydroxide or sodium carbonate to the water.

As an illustrative example of the methods disclosed herein, an industrial paint system may include a paint spray booth, a system tank, a consolidation tank, and a dewatering apparatus. The system tank may be a containment defining a number of system tank inlets (such as one, two, three, four, or more inlets) and a number of system tank outlets (such as one, two, three, four, or more). A system tank inlet may be fluidly connected to an external water source via a conduit. The external water source may be a source of water located external to the industrial paint system and may be, for example, fresh water, municipal water, tap water, or another water source. The water source may be added through an inlet to the system tank. An inlet of the system tank may be fluidly connected to the paint spray booth via a conduit at a spray booth outlet. An inlet of the system tank may be fluidly connected to the dewatering apparatus via a conduit at a dewatering apparatus outlet. An outlet of the system tank may be fluidly connected via a conduit to a wastewater disposal and/or collection area for disposal and/or further treatment of wastewater materials. An outlet of the system tank may be fluidly connected to a consolidation tank via a conduit at a consolidation tank inlet. An outlet of the system tank may be fluidly connected to the paint spray booth via a conduit at a paint booth inlet. An outlet of the consolidation tank may be fluidly connected to a conduit. An outlet of the consolidation tank may be fluidly connected to the dewatering apparatus via a conduit at an inlet of the dewatering apparatus. Also, an outlet of the dewatering apparatus may be connected to a waste disposal and/or collection area for disposal and/or further treatment of dewatered solid waste materials. Various treatment inlets may be used for applying or adding one or more of a colloidal particle, inorganic salt, polymer, composition, compound, and/or additional additive (e.g., coagulant, flocculant, etc.) to the industrial paint system.

Any of the treatment chemicals disclosed herein (e.g., colloidal particle, inorganic salt, polymer, flocculant, coagulant, etc.) may be added to the system tank or a conduit of an industrial paint system in an amount of about 0.01 ppm to about 10,000 ppm w/v (weight/volume), such as about 0.01 ppm to about 8,000 ppm w/v, about 0.01 ppm to about 6,000 ppm w/v, about 0.01 ppm to about 4,000 ppm w/v, about 0.01 ppm to about 2,000 ppm w/v, about 0.01 ppm to about 1,000 ppm w/v, about 0.01 ppm to about 800 ppm w/v, about 0.01 ppm to about 600 ppm w/v, about 0.01 ppm to about 400 ppm w/v, about 0.01 ppm to about 300 ppm w/v, about 0.01 ppm to about 200 ppm w/v, about 0.01 ppm to about 100 ppm w/v, or about 0.01 ppm to about 50 ppm w/v.

In certain methods disclosed herein, a first paint overspray-laden air source is directed through a first mobile floodsheet including a first treated washwater, wherein the first mobile floodsheet is either a side-draft or down-draft type (that is, a horizontal or vertical “waterfall”) that contacts the first paint overspray-laden air source, forming a first treated overspray and a first cleaned air source.

Further, in a continuous flow waterwash booth system, the first treated overspray is collected, such as by accumulating in a tank, and one or more flocculants may be added to the first collected treated overspray to form a first flocculated overspray, the first flocculated overspray including one or more associated complexes. The associated complexes are separated from the first flocculated overspray using one or more solid-liquid separation techniques, such as skimming, gravity filtration, suction filtration, cyclonic separation, settling/decanting, or combinations of two or more thereof to provide a first aqueous treatment residue.

In some embodiments of a continuous flow waterwash booth system, a first aqueous treatment residue is used as the water source for forming a second treated washwater, wherein a second amount of a treatment composition is added to the first aqueous treatment residue to form a second treated washwater. Accordingly, in a continuous flow waterwash booth system, a first “cycle of use” may begin with the formation of a first mobile floodsheet formed from a first treated washwater, and it may end with the return of a first aqueous treatment residue thereof to form a second mobile floodsheet formed from a second treated washwater.

The methods, uses, and compositions disclosed herein provide a paint overspray waterwash system that may reach up to 500,000 cycles of use before conductivity of a treated washwater reaches a selected limit, such as 40,000 μS/cm, which may be when the paint overspray waterwash system requires complete replacement of the water source and formation of fresh treated washwater. However, the conductivity maximum may be selected based on the particular system and may be any value other than 40,000 μS/cm, such as 20,000 μS/cm or less, 30,000 μS/cm, 50,000 μS/cm, or 60,000 μS/cm or more.

The overspray waterwash system employing the method disclosed herein may cause the treated washwater to contact a paint particle or aerosol present within a paint booth to form a treated overspray.

In some embodiments, the methods disclosed herein further include collecting a treated overspray. The treated overspray is suitably collected using conventional collection equipment adapted and designed to receive a paint booth overspray washwater after contacting the washwater with a paint overspray, as is familiar to one of ordinary skill in the art of paint overspray waterwash systems. Suitable collection equipment includes, but is not limited to, equipment for contacting a paint overspray with a washwater, as described above, that is fluidly connected to a tank or other containment designed and adapted to receive and contain a paint booth overspray washwater. In some embodiments, a collected treated overspray is applied to a tank or other containment adapted and designed to receive and contain a paint booth overspray washwater.

The paint detackifier compositions of the present disclosure can improve the purifying treatment efficiency of oversprayed paint wastewater, decrease turbidity and chemical oxygen demand, extend service life of recirculating water, and reduce replacement times of recirculating water. The paint detackifier compositions of the present disclosure have a beneficial detackification effect for various water-based or solvent-based paints.

The foregoing may be better understood by reference to the following examples, which are intended for illustrative purposes and are not intended to limit the scope of the disclosure or its application in any way.

### EXAMPLES

### Paint Detackification Test Procedure

A clean glass jar will be charged with about 200 ml of clarified paint booth water or tap water, and about 0.1 to about 0.6 mL of a detackifier that will either comprise a colloidal particle as described herein or a suitable control material will be added to the jar. Optionally, a coagulant may also be added to the jar. If pH is adjusted, a buffer solution or a dilute sodium hydroxide solution will be added to the jar to provide the targeted pH. The pH may be adjusted before or after addition of the detackifier. The jar will be tightly capped and swirled vigorously. During the swirling, about 0.3 mL to about 0.5 mL of a paint material will be added dropwise to the jar. Then, the jar will be capped and swirled vigorously for an additional 10-30 seconds.

Then, about 0.5 mL to about 1.0 mL of a 1 wt % solution of a cationic acrylamide copolymer (“flocculant”), will be added to the jar and the jar will be gently swirled for about 15 seconds to thoroughly mix all components. Next, the contents of the jar will be poured into a clear disposable plastic cup and observations regarding sludge tackiness, “sludge quality”, and turbidity of the supernatant liquid in the cup will be recorded.

“Poor” sludge quality will mean small or small to medium clumps of solids are floating on the surface that appear partly dispersed, and settled solids are clearly visible at bottom of jar; “Good” sludge quality will mean most of the solids in the jar are floating on surface in medium to large clumps that are compact, with very little or some evidence of dispersion; and very little or some visible settled solids at the bottom of the jar; and “Excellent” sludge quality will mean large clumps of solids are floating on surface of water that are highly compact with no evidence of dispersion; and no settled solids are visible at bottom of jar.

Additionally, turbidity of the supernatant water phase may be measured using a nephelometer (turbidity meter) where turbidity is reported in nephelometric turbidity units (NTU). Further, turbidity rating of “Excellent” will mean turbidity of 20 NTU or less, further wherein the visual appearance of the supernatant water phase may be substantially clear, with very little to no cloudiness visible and very little to no solids visibly dispersed therein; turbidity rating of “Good” will mean turbidity between about 20 and 50 NTU, further wherein some solids and/or cloudy appearance of the supernatant water phase is apparent; and turbidity rating of “Poor” will mean turbidity of 50 NTU or more, further wherein the visual appearance of the supernatant water phase may be very cloudy, and/or large amounts of solids are visibly dispersed therein.

If any masses of solid are observed in the jar, a small amount of the mass may be removed from the jar and rubbed between clean, wetted fingers in order to provide observations regarding “tackiness” of the mass. A completely detackified mass is not sticky when rubbed between wetted fingers and leaves no visible smeared paint on the fingers.

Whether we use a water-based paint or a solvent-based paint, we expect to see that while an inorganic salt, such as aluminum sulfate, may be used to detecktify paint, high dosages will be required. However, when a colloidal particle is used (inorganic salt (e.g., aluminum sulfate)/polymer complex), a much lower dosage can be used to achieve the same effect or an even greater detackifying effect. Thus, a synergistic effect will be seen between the polymer and the inorganic salt.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more polymers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of detackifying paint, comprising:
adding a polymer to an aqueous medium of an industrial paint system;
adding an aluminum salt and/or ferric salt to the aqueous medium;
forming a colloidal particle in the aqueous medium, the colloidal particle comprising the polymer embedded within a colloidal aluminum hydroxide complex and/or a colloidal ferric hydroxide complex;
adding paint to the aqueous medium; and
detackifying the paint.

2. The method of claim 1, further comprising adding a flocculant to the aqueous medium, wherein the flocculant is selected from the group consisting of an anionic polymer, a cationic polymer, an amphoteric polymer, a nonionic polymer, and any combination thereof.

3. The method of claim 1, further comprising adding a coagulant to the aqueous medium, wherein the coagulant is selected from the group consisting of a polyionic compound, an inorganic salt, an organic compound, and any combination thereof.

4. The method of claim 1, further comprising adjusting a pH of the aqueous medium to between about 6.5 and about 10.

5. The method of claim 1, further comprising separating the detackified paint from the aqueous medium.

6. The method of claim 1, wherein the polymer comprises a monomer selected from the group consisting of an anionic monomer, a cationic monomer, a non-ionic monomer, a zwitterionic monomer, and any combination thereof.

7. The method of claim 1, wherein the polymer comprises from about 2 mol % to about 10 mol % of a cationic monomer, about 1 mol % to about 5 mol % of an anionic monomer, and about 97 mol % to about 85 mol % of a non-ionic monomer.

8. The method of claim 7, wherein the non-ionic monomer is acrylamide, the cationic monomer is selected from the group consisting of DADMAC, MAPTAC, and DMAEA.MCQ, and the anionic monomer is acrylic acid.

9. The method of claim 1, wherein the polymer is an amphoteric polymer having a net cationic charge.

10. The method of claim 1, wherein the colloidal particle comprises from about 1 wt. % to about 30 wt. % of the polymer and from about 70 wt. % to about 99 wt. % of the aluminum hydroxide and/or the ferric hydroxide.

11. The method of claim 1, further comprising adding an aqueous composition to the aqueous medium, the aqueous composition comprising the polymer and the aluminum salt and/or ferric salt, wherein the aqueous composition comprises a pH from about 2 to about 7.

12. The method of claim 1, wherein the polymer and the aluminum salt and/or the ferric salt are added separately to the aqueous medium.

13. The method of claim 1, wherein the polymer comprises from about 0.1 mol % to about 10 mol % of a carboxylic acid.

14. The method of claim 1, wherein the polymer comprises a Huggins constant of about 0.0 to about 1.

15. The method of claim 1, wherein the aluminum salt is selected from the group consisting of aluminum chloride, aluminum chloride hydrate, aluminum sulfate, alum, PAC, aluminum chlorohydrate, a compound having the formula AlₙCl₍₃ₙ₋ₘ₎(OH)ₘ, wherein m is an integer from 0-100, n is an integer from 1-100, and m is less than 3n, and any combination thereof.

16. The method of claim 1, wherein the ferric salt is selected from the group consisting of ferric chloride, ferric sulfate, a polyferric salt, and any combination thereof.

17. An aqueous medium of an industrial paint system, comprising:
a water source, paint, and from about 0.01 ppm to about 10,000 ppm by weight of a colloidal particle, the colloidal particle comprising a polymer embedded within a colloidal aluminum hydroxide complex and/or a colloidal ferric hydroxide complex.

18. The aqueous medium of claim 17, wherein the water source comprises a paint overspray washwater.

19. The aqueous medium of claim 17, further comprising from about 0.01 ppm to about 1,000 ppm by weight of a coagulant and/or from about 0.01 ppm to about 1,000 ppm by weight of a flocculant.

20. A method of detackifying paint, comprising:
adding a composition to an aqueous medium of an industrial paint system to form a treated aqueous medium, wherein the composition comprises a colloidal particle, the colloidal particle comprising a polymer embedded within a colloidal aluminum hydroxide complex and/or a colloidal ferric hydroxide complex;
adding paint to the treated aqueous medium; and
detackifying the paint.
